(19) United States
(12) Patent Application Publication
(10) Pub. No.: US 2024/0131829 A1
(43) Pub. Date: Apr. 25, 2024

(54) HIGH-BARRIER MULTILAYER FILM AND PACKAGING CONTAINER MADE THEREFROM

(71) Applicant: Braskem S.A., Camaçari (BR)

(72) Inventors: Francisco Carlos Ruiz, São Paulo City (BR); Daiane Schilling de Vargas, São Paulo City (BR); Mauro Alfredo Soto Oviedo, São Paulo City (BR); Bárbara Iria Silva Mano, Pittsburgh, PA (US); Amanda Zani Dutra Silva, Pittsburgh, PA (US)

(73) Assignee: Braskem S.A., Camaçari (BR)

(21) Appl. No.: 18/381,432

(22) Filed: Oct. 18, 2023

Related U.S. Application Data
(60) Provisional application No. 63/417,165, filed on Oct. 18, 2022.

(51) Int. Cl. B32B 27/08; B32B 27/32; B32B 33/00; B32B 38/00

(52) U.S. Cl. CPC B32B 27/08; B32B 27/32; B32B 33/00; B32B 38/0012; B32B 2038/0028; B32B 2255/10; B32B 2255/26; B32B 2255/28; B32B 2307/406; B32B 2307/514; B32B 2307/72; B32B 2307/7244; B32B 2307/7246; B32B 2323/043; B32B 2553/00

(57) ABSTRACT

A coated polymeric multilayer article including: (i) a polymer substrate including (a) a first polyolefin-based layer including a primary ethylene-based polymer; and (b) an adhesion layer on at least one surface of the first polyolefin-based layer including one or more secondary ethylene-based polymers selected from secondary polyethylene homopolymers, secondary ethylene-based copolymers of ethylene with one or more C3-C10 alpha olefin monomers or ethylene-vinyl acetate (EVA) copolymer; and (ii) a coating layer on at least one surface of the adhesion layer. A method of producing a coated polymeric multilayer article, the method including the steps of: forming a polymer substrate including a first polyolefin-based layer and an adhesion layer on at least one surface of the polyolefin-based layer; and applying a coating layer composition on at least one surface of the adhesion layer.

### BACKGROUND

Polymeric films are widely used, both in industrial manufacturing processes and in the consumer sector for the delivery of goods to the consumer market including, for example, household disposables, trash bags and liners, overwrap films and bags for laundry and dry-cleaning goods, shipping, and carryout bags for retail merchandising of non-perishable goods, and packaging materials in general.

Depending on the properties desired, the films may be formed from polypropylene, polyvinylchloride, polyethylene, and polyethylene terephthalate. Multilayer constructions are commonly used to achieve the desired properties. Polymeric articles such as biaxially oriented polypropylene or polyethylene films are an important example of such constructions due to the desire to have a fully recyclable polypropylene or polyethylene film.

Oriented films of resins such as polyethylene and polypropylene oriented films are known for having suitable properties for application as packaging materials, for example, heat resistance, transparency, and mechanical properties in general. Hence, they are widely used for this purpose. However, polyethylene and polypropylene oriented films may not fulfill the necessary barrier properties for specific applications, particularly applications wherein permeation of molecules such as oxygen or other gases, water and organoleptic compounds are not desired. Examples of such applications include food, homecare goods, personal care, and cosmetic products.

Aiming at improving the barrier properties of polymeric films, barrier coatings are applied to reduce the permeation of compounds such as water vapor, oxygen, organoleptic compounds related to odors and flavors, toxic compounds, and contaminants. The permeation is not only related to passage of external compounds to the insides of the package. The coating also helps to keep compounds of interest inside the package such as gases, moisture or organoleptic compounds related to odors and flavors, in order to maintain all the content and properties of the original product.

The resulting coated polymeric films must fulfill the high barrier requirements related to the molecules and compositions mentioned above, especially when used in packaging materials or other goods wherein permeability is unwanted. Moreover, the coating must be strongly adhered to the polymeric film to guarantee the integrity of the coating over time, also preserving the barrier properties required for its application. The high resistance and adhesion of the barrier coating applied on the polymeric film is also important for it withstand the handling of the film during the production of the package and the handling of the consumer. The coated polymeric film must preferably be flexible and have suitable mechanical properties, heat resistance to be used for the intended application. Good transparency is also desired. In a preferred manner, the coated polymeric article is partially or fully recyclable, using as less types of material as possible, but preserving its barrier properties, mechanical properties, heat resistance and transparency.

Accordingly, there exists a need for coated polymeric articles capable of fulfilling the requirements above.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a coated polymeric multilayer article including: (i) a polymer substrate including (a) a first polyolefin-based layer including a primary ethylene-based polymer; and (b) an adhesion layer on at least one surface of the first polyolefin-based layer including one or more secondary ethylene-based polymers selected from secondary polyethylene homopolymers, secondary ethylene-based copolymers of ethylene with one or more C3-C10 alpha olefin monomers or ethylene-vinyl acetate (EVA) copolymer; and (ii) a coating layer on at least one surface of the adhesion layer.

In another aspect, the present disclosure relates to a method of producing a coated polymeric multilayer article, the method including the steps of: forming a polymer substrate including a first polyolefin-based layer and an adhesion layer on at least one surface of the polyolefin-based layer; and applying a coating layer composition on at least one surface of the adhesion layer.

In another aspect, the present disclosure relates to a packaging comprising the polymeric multilayer article of the present disclosure, wherein the packaging is a food package, a homecare product package, a personal care product package, or a package for cosmetic products.

### BRIEF DESCRIPTION OF DRAWINGS

FIG. 1 shows an example of a tenter frame system for producing the polymer substrate according to the present disclosure.

FIG. 2 shows a schematic representation of Comparative Example and Example 1 layers.

### DETAILED DESCRIPTION

### Coated Polymeric Multilayer Article

In one aspect, embodiments disclosed herein relate to a coated polymeric multilayer article comprising: (i) a polymer substrate comprising (a) a first polyolefin-based layer; and (b) an adhesion layer on at least one surface of the first polyolefin-based layer; and (ii) a coating layer on at least one surface of the adhesion layer.

### Polymer Substrate and Polyolefins

For the purposes of the present disclosure, the term “polymer substrate” is to be understood as one or more consecutive layers of polymeric materials. If more than one layer is present, it is to be understood there are two or more consecutive layers of polymeric materials, being possible to have adhesive layers between consecutive layers, particularly if the layers are laminated over each other. Each layer of polymeric materials may be composed of a single polymer material, or a combination of different polymer materials. Different layers of polymer materials may comprise or be composed of the same polymeric material(s) or of different polymeric material(s).

The polymer substrate according to the present disclosure comprise at least one polyolefin-based layer. For the purposes of the present disclosure, in expressions such as “polyolefin-based”, “ethylene-based”, “propylene-based” and the like, the term “based” may refer to at least 30%, at least 35%, at least 40%, at least 45%, at least 50%, at least 51%, at least 55%, at least 60%, at least 65%, at least 70%, at least 75%, at least 80%, at least 85%, at least 90%, at least 95%, at least 96%, at least 97%, at least 98%, at least 99%, at least 99.9% or even 100% by weight, based on the total weight of the cited element or feature. Hence, the polyolefin-based layer(s) according to the present disclosure comprise at least 30%, at least 35%, at least 40%, at least 45%, at least 50%, at least 51%, at least 55%, at least 60%, at least 65%, at least 70%, at least 75%, at least 80%, at least 85%, at least 90%, at least 95%, at least 96%, at least 97%, at least 98%, at least 99%, at least 99.9% or even 100% by weight of polyolefin, based on the total weight of each polyolefin-based layer. The term “polyolefin” relates to polymers obtained by the polymerization of olefins (i.e., alkenes), preferably C₂-C₆ alkenes, alone or in combination with other comonomers, then referring to homopolymers of alkenes, or to copolymers of alkenes with one or more comonomers of interest. Examples of polyolefins include polyethylene, polypropylene, poly(1-butene), polyisobutylene and polymethylpentene, in the form of homopolymers or copolymers with one or more comonomers of interest.

The total number of polyolefin-based layers in the polymer substrate of the present disclosure is not particularly limited. The polymer substrate according to the present disclosure may comprise one or more polyolefin-based layers depending on the properties, especially mechanical and barrier properties, intended for the final application of the coated polymeric article. In a preferred embodiment, the polymer substrate according to the present disclosure comprise one, two, three, four, five, six, seven, eight, nine, ten, or even more polyolefin-based layers. The polymer substrate according to the present disclosure also comprises an adhesion layer.

The polyolefins according to the present disclosure are preferably selected from ethylene-based polymers, propylene-based polymers, and mixtures thereof. The propylene-based polymers may be selected from the group consisting of polypropylene copolymers, polypropylene homopolymers, or mixtures thereof. The ethylene-based polymers are selected from polyethylene copolymers, polyethylene homopolymers, or mixtures thereof. The term “copolymer” refers to a polymer having one or more comonomers, therefore it also includes terpolymers or higher copolymers. In the context of the present disclosure, the term “mixtures thereof” also includes mixtures of different polymers, homopolymers or copolymers within the same group. For example, the term “polyethylene copolymer, polyethylene homopolymer, or mixtures thereof” and the like not only refer to mixtures of polyethylene copolymers with polyethylene homopolymers, but also to mixtures of different grades of polyethylene copolymers, or mixtures of different grades of polyethylene homopolymers. Similar interpretation is given for other occurrences of the term “mixtures thereof” in the present disclosure, when feasible.

The ethylene-based polymers according to the present disclosure may include high density polyethylene (HDPE), very low density polyethylene (VLDPE), low density polyethylene (LDPE), linear low density polyethylene (LLDPE), ultra-high molecular weight polyethylene (UHMWPE), ethylene-vinyl acetate copolymer (EVA), and mixtures thereof.

In one or more embodiments, ethylene-based polymers of the present disclosure may include ethylene-based homopolymers produced from ethylene. In other embodiments, the ethylene-based polymers may include ethylene-based copolymers produced from ethylene and one or more comonomers, such as C3-C10 alpha olefin or vinyl acetate. Hence, the term “ethylene-based polymer” includes both the homopolymers produced from ethylene and copolymers produced from ethylene and one or more comonomers, and mixtures thereof.

For the purposes of the present disclosure, the term “ethylene-based copolymers” and the like relates to ethylene-based copolymers produced from ethylene and one or more C3-C10 alpha olefin comonomers, such as ethylene and one C3-C10 alpha olefin comonomer. Preferably, the one or more C3-C10 alpha olefin comonomers are selected from the group consisting of 1-propene, 1-butene, 1-pentene, 1-hexene, 1-heptene, 1-octene, 1-nonene, 1-decene or mixtures thereof, more preferably 1-butene, 1-hexene, 1-octene or mixtures thereof. In particular embodiments, the ethylene-based copolymers may include one or more C4-C8 alpha olefin comonomers, preferably selected from 1-butene, 1-pentene, 1-hexene, 1-heptene, 1-octene or mixtures thereof, more preferably 1-butene, 1-hexene, 1-octene or mixtures thereof.

Ethylene-based polymers according to the present disclosure also include ethylene-vinyl acetate copolymers (EVA).

The polyolefins according to the present disclosure may be classified as primary polyolefins and secondary polyolefins. The terms “primary” and “secondary” in the present disclosure are not attached to specific properties, structures, or composition of the polyolefins, and they are made for the sake of clarity of the present disclosure.

In one or more embodiments, the primary polyolefins are different than the secondary polyolefins. In one or more embodiments, the primary polyolefins have higher density than the secondary polyolefins, when each polyolefin grade is considered individually or even in a mixture of polyolefins.

### Primary Polyolefins

In one or more embodiments, the primary polyolefins according to the present disclosure are selected from primary ethylene-based polymers. The primary ethylene-based polymers according to the present disclosure may include high density polyethylenes (HDPE), very low density polyethylenes (VLDPE), low density polyethylenes (LDPE) and linear low density polyethylenes (LLDPE). In a preferred embodiment, the primary ethylene-based polymers are selected from HDPE, LLDPE or LDPE, more preferably from HDPE.

The primary ethylene-based polymers are selected from primary ethylene-based homopolymers and primary ethylene-based copolymers. In one or more embodiments, the primary ethylene-based copolymers are selected from ethylene-based copolymers of ethylene with one or more C3-C10 alpha olefin comonomers, such as ethylene and one C3-C10 alpha olefin comonomer. Preferably, the one or more C3-C10 alpha olefin comonomers are selected from of 1-propene, 1-butene, 1-pentene, 1-hexene, 1-heptene, 1-octene, 1-nonene, 1-decene or mixtures thereof, more preferably 1-butene, 1-hexene, 1-octene or mixtures thereof. In particular embodiments, the primary ethylene-based copolymers are selected from ethylene-based copolymers produced from ethylene and one or more C4-C8 alpha olefin comonomers, preferably selected from 1-butene, 1-pentene, 1-hexene, 1-heptene, 1-octene or mixtures thereof, more preferably 1-butene, 1-hexene, 1-octene or mixtures thereof.

In more particular embodiments, the primary ethylene-based polymers are selected from ethylene-based homopolymers, ethylene-based copolymers of ethylene with 1-butene, ethylene-based copolymers of ethylene with 1-hexene, ethylene-based copolymers of ethylene with 1-octene or ethylene-based terpolymers of ethylene with 1-butene and 1-octene.

In some embodiments, the primary ethylene-based polymer may have an ethylene content ranging from a lower limit selected from one of 90 mol %, 91 mol %, 92 mol %, 93 mol %, 94 mol %, 95 mol % to an upper limit selected from one of 95 mol %, 96 mol %, 97 mol %, 98 mol %, 99 mol %, 99.5 mol %, 99.9 mol %, and 100 mol % of the total number of moles of the ethylene-based polymer, where any lower limit may be paired with any upper limit, when feasible.

In some embodiments, the primary ethylene-based copolymer may have an ethylene content ranging from a lower limit selected from one of 90 mol %, 91 mol %, 92 mol %, 93 mol %, 94 mol %, 95 mol % to an upper limit selected from one of 95 mol %, 96 mol %, 97 mol %, 98 mol %, 99 mol %, 99.5 mol % and 99.9 mol % of the total number of moles of the ethylene-based copolymer, where any lower limit may be paired with any upper limit, when feasible.

In one or more embodiments, the primary ethylene-based copolymer may have a content of one or more C3-C10 alpha olefin comonomers ranging from a lower limit selected from one of 0.1 mol %, 0.5 mol %, 1.0 mol %, 2.0 mol %, 3.0 mol %, 4.0 mol %, 5.0 mol % to an upper limit selected from one of 5.0 mol %, 6.0 mol %, 7.0 mol %, 8.0 mol %, 9.0 mol %, and 10 mol % of the total number of moles of the primary ethylene-based copolymer, where any lower limit may be paired with any upper limit, when feasible. Comonomer content can be measured by NMR spectroscopy.

In one or more embodiments, the primary ethylene-based polymer may be formed in the presence of Ziegler Natta, metallocene, single-site or chromium catalysts. Ziegler Natta catalysts used to polymerize ethylene may include titanium-based and optionally, vanadium-based compounds. Catalysts as disclosed herein may be non-supported catalysts or catalysts supported on particulate supports. The particulate support may be an inorganic-oxide-based compound and may include silica, alumina, titania, silica-alumina and silica-titania. In particular embodiments, catalysts may be a non-supported Ziegler-Natta catalyst comprising titanium and vanadium-based compounds.

In one or more embodiments, the primary ethylene-based polymer may have a density, according to ASTM D792, ranging from a lower limit selected from one of 940 kg/m³, 942 kg/m³, 945 kg/m³, 946 kg/m³, 947 kg/m³, 948 kg/m³, 949 kg/m³, 950 kg/m³, 951 kg/m³, 952 kg/m³, 953 kg/m³ and 954 kg/m³ to an upper limit selected from 953 kg/m³, 954 kg/m³, 955 kg/m³, 956 kg/m³, 957 kg/m³, 958 kg/m³, 959 kg/m³, 960 kg/m³ and 961 kg/m³ where any lower limit may be paired with any upper limit, when feasible.

In one or more embodiments, the primary ethylene-based polymer may have a melt flow rate (MFR₂), according to ASTM D1238 at 190° C./2.16 kg, ranging from a lower limit selected from 0.5 g/10 min, 0.7 g/10 min, 1.0 g/10 min, 1.3 g/10 min, 1.6 g/10 min, 1.8g/10 min and 1.9 g/10 min to an upper limit selected from 1.8g/10 min, 2.0 g/10 min, 2.5 g/10 min, 2.8 g/10 min, and 3.0 g/10 min, where any lower limit may be paired with any upper limit, when feasible.

In one or more embodiments, a stress exponent (SEx) of the primary ethylene-based polymer may be calculated using the following equations I and II:

$$S E x = \frac{log {MFR}_{6} - Log {MFR}_{2}}{Log 6480 - Log 2160} \qquad ( I )$$

$$SEx = \frac{Log R}{0.477} \qquad ( II )$$

where MFR₂ represents a melt flow rate according to ASTM 1238 at 190° C./2.16 kg, MFR₆ represents a melt flow rate according to ASTM 1238 at 190° C./6.48 kg and R is a ratio of MFR₆ and MFR₂.

In some embodiments, the primary ethylene-based polymer may have a SEx ranging from a lower limit selected from 1.0, 1.1, 1.2, 1.23, 1.27, 1.30, 1.31, 1.32, 1.33, 1.34 to an upper limit selected from 1.37, 1.4, 1.5, 1.6 and 1.8, where any lower limit may be paired with any upper limit.

In one or more embodiments, the primary ethylene-based polymer may have a weight average molecular weight (Mw), measured by gas permeation chromatography (GPC), ranging from 80,000 g/mol to 140,000 g/mol. For example, the Mw may range from a lower limit of any of 80,000 g/mol, 85,000 g/mol, 90,000 g/mol, or 100,000 g/mol, and an upper limit of any of 100,000 g/mol, 110,000 g/mol, 115,000 g/mol, 120,000 g/mol, or 140,000 g/mol where any lower limit can be used in combination with any upper limit.

In one or more embodiments, the primary ethylene-based polymer may have a number average molecular weight (Mn), measured by GPC, ranging from 4,000 g/mol to 22,000 g/mol. For example, the Mn may range from a lower limit of any of 4,000 g/mol, 6,000 g/mol, 10,000 g/mol, or 12,000 g/mol, to an upper limit of any of 12,000, 15,000 g/mol, 18,000 g/mol, 20,000 g/mol, or 22,000 g/mol, where any lower limit can be used in combination with any upper limit.

In one or more embodiments, the primary ethylene-based polymer may have a Z average molecular weight (Mz), measured by GPC, ranging from 180,000 g/mol to 650,000 g/mol. For example, the Mz may range from a lower limit of any of 180,000 g/mol, 200,000 g/mol, 250,000 g/mol, 300,000 g/mol, or 350,000 g/mol, to an upper limit of any of 400,000 g/mol, 450,000 g/mol, 500,000 g/mol, 550,000 g/mol, 600,000 g/mol, or 650,000 g/mol, where any lower limit can be used in combination with any upper limit.

In one or more embodiments, the primary ethylene-based polymer may have a molecular weight distribution (MWD), represented by a ratio of Mw and Mn (Mw/Mn), ranging from a lower limit selected from 3, 4, 5, 6, 7, 8, 9 and 10 to an upper limit selected from 10, 12, 13, 15, 20, 21, 22, 23, 24 and 25, where any lower limit may be paired with any upper limit, when feasible.

In one or more embodiments, primary ethylene-based polymer may have a monomodal molecular weight distribution, a bimodal molecular weight distribution or a multimodal molecular weight distribution. In particular embodiments, primary ethylene-based polymer may have a monomodal molecular weight distribution.

As used herein, the term “monomodal” or “bimodal” when used to describe polymers, such as polyethylenes, refers to a “monomodal molecular weight distribution” or a “bimodal molecular weight distribution”, which term is understood to have the broadest definition for people skilled in the art have given that term as reflected in one or more printed publications or issued patents. A material having one distinct molecular weight distribution peak will be considered to be “monomodal” as that term is used herein. When a material having two or more distinct molecular weight distribution peaks will be considered to be “bimodal” as that term is used herein although the material may also be referred to as a “multimodal” composition, e.g., a trimodal or even tetramodal composition, etc.

In one or more embodiments, the primary ethylene-based polymer may have a melt temperature Tm according to ASTM 3418 ranging from a lower limit selected from 110° C., 111° C., 112° C., 113° C., 114° C., 115° C., 116° C., 117° C., 118° C., 119° C., 120° C. and 125° C. to an upper limit selected from 125° C., 130° C., 131° C., 132° C., 133 ºC, 134° C., 135° C., 136° C., 137° C., 138° C., 139° C. and 140° C., where any lower limit may be paired with any upper limit, when feasible.

In one or more embodiments, the primary ethylene-based polymer may have a crystallization temperature (Tc) according to ASTM 3418 ranging from a lower limit selected from 65° C., 70° C., 75° C., to an upper limit selected from 115° C., 120° C., 125° C., where any lower limit may be paired with any upper limit.

In one or more embodiments, the primary ethylene-based polymer may have a complex viscosity at 0.09 rad/s ranging from 3,000 to 25,000 Pa·s.

In one or more embodiments, the primary ethylene-based polymer may have a complex viscosity at 300 rad/s ranging from 100 to 2,000 Pa·s.

In one or more embodiments, the primary ethylene-based polymer may have a shear thinning index SHI_{5/200}, being the ratio of the complex shear modulus at 5 kPa to the complex shear modulus at 200 kPa, of from 2 to 18.

In one or more embodiments, the primary ethylene-based polymer may have a shear thinning index SHI_{2.7/210}, being the ratio of the complex shear modulus at 2.7 kPa to the complex shear modulus at 210 kPa, of from 2 to 26.

In one or more embodiments, the primary ethylene-based polymer may have an elasticity balance tan 0.09/tan 300, being the ratio of the loss tangent at 0.09 rad/s to the loss tangent at 300 rad/s of from 1 to 26.

In one or more embodiments, the primary ethylene-based polymer may have a total biobased carbon content in a range having a lower limit selected from any of 5, 10, or 20%, to an upper limit selected from any of 50%, 90%, and 100%, where any lower limit may be combined with any upper limit. Biobased products obtained from natural materials may be certified as to their renewable carbon content, according to the methodology described in the technical standard ASTM D 6866-18, “Standard Test Methods for Determining the Biobased Content of Solid, Liquid, and Gaseous Samples Using Radiocarbon Analysis”.

The total bio-based or renewable carbon in the primary ethylene-based polymer may be contributed from a bio-based ethylene. For example, in one or more embodiments, the renewable source of carbon is one or more plant materials selected from the group consisting of sugar cane and sugar beet, maple, date palm, sugar palm, sorghum, American agave, corn, wheat, barley, sorghum, rice, potato, cassava, sweet potato, algae, fruit, materials comprising cellulose, wine, materials comprising hemicelluloses, materials comprising lignin, wood, straw, sugarcane bagasse, sugarcane leaves, corn stover, wood residues, paper, and combinations thereof.

In one or more embodiments, the bio-based ethylene may be obtained by fermenting a renewable source of carbon to produce ethanol, which may be subsequently dehydrated to produce ethylene. Further, it is also understood that the fermenting produces, in addition to the ethanol, byproducts of higher alcohols. If the higher alcohol byproducts are present during the dehydration, then higher alkene impurities may be formed alongside the ethanol. Thus, in one or more embodiments, the ethanol may be purified prior to dehydration to remove the higher alcohol byproducts while in other embodiments, the ethylene may be purified to remove the higher alkene impurities after dehydration.

Thus, biologically sourced ethanol, known as bioethanol, is obtained by the fermentation of sugars derived from cultures such as that of sugar cane and beets, or from hydrolyzed starch, which is, in turn, associated with other cultures such as corn. It is also envisioned that the bio-based ethylene may be obtained from hydrolysis-based products of cellulose and hemi-cellulose, which can be found in many agricultural by-products, such as straw and sugar cane husks. This fermentation is carried out in the presence of varied microorganisms, the most important of such being the yeast Saccharomyces cerevisiae. The ethanol resulting therefrom may be converted into ethylene by means of a catalytic reaction at temperatures usually above 300° C. A large variety of catalysts can be used for this purpose, such as high specific surface area gamma-alumina. Other examples include the teachings described in U.S. Pat. Nos. 9,181,143 and 4,396,789, which are herein incorporated by reference in their entirety.

In one or more embodiments, the primary ethylene-based polymer may contain a number of functional additives that modify various properties of the composition. Such additives may include antioxidants, acid scavengers, pigments, fillers, reinforcements, adhesion-promoting agents, biocides, whitening agents, nucleating agents, anti-statics, anti-blocking agents, processing aids, flame-retardants, plasticizers, light stabilizers, UV stabilizers and the like.

In some embodiments, the primary ethylene-based polymer may have an additive content ranging from a lower limit selected from 0 wt %, 1 wt %, and 2 wt % to an upper limit selected from 3 wt %, 4 wt %, and 5 wt % based on the total weight of the primary ethylene-based polymer, where any lower limit may be paired with any upper limit.

The primary ethylene-based polymers according to the present disclosure may be produced in any known polymerization process, including but not limited to solution polymerization, gas phase polymerization, or slurry polymerization. In particular embodiments, the polymerization process is a solution polymerization process. Generally, in solution polymerizations, both the catalyst and the resulting polymer remain dissolved in a solvent that must be removed to isolate the polymer. Various solvents may be used, such as linear, branched or cyclic C₅ to C₁₂ alkanes, including, for example, cyclohexane. Ethylene may be solubilized in cyclohexane and sent to a reaction area. Alpha-olefins, such as 1-propene, 1-butene, 1-pentene, 1-hexene, 1-heptene, 1-octene, 1-nonene, 1-decene may be used as a comonomer to determine the density of the product.

In the reaction section, a catalytic solution is injected to promote the polymerization of the ethylene and the comonomer. Solution polymerization may include non-adiabatic reactors as well as adiabatic reactors. For example, in one or more embodiments, several adiabatic tubular reactors (e.g., three), may be followed by a stirred autoclave, and then an adiabatic tubular (Trimmer), respectively. The operating conditions of the system may be adjusted depending on the type of polymer being produced and depending on the desired properties such as molecular weight distribution (MWD), density and melt index. Generally, the temperature profile in the reactors may range from 105 to 315° C., depending on the reaction module. For example, it is envisioned that there are two reaction modules: Module 1 and Module 2. In Module 1, the catalyst is injected into the stirred autoclave (when the agitator is in operation), while the non-adiabatic reactor behaves like a pipeline (no reaction). In Module 2, the catalyst is injected into the inlet of the non-adiabatic reactor, and the agitator of the autoclave reactor remains stopped. In all cases the Trimmer reactor is in operation. The operating pressure can range from 120 kgf/cm² to 160 kgf/cm².

In particular embodiments, such solution polymerization takes place under the presence of first-generation Ziegler-Natta type catalysts comprising titanium and vanadium. Catalysts may be activated in three steps in the process before entering the reactor. In the first activation step, the catalyst is mixed with a reducing agent. After reduced, the catalyst undergoes a thermal treatment with heated cyclohexane (210-260° C.) and then mixed with an alkylating agent (alkylation). In some embodiments the catalyst can be injected at the entrance of the first tubular reactor and the properties are controlled through the reaction temperature profile, hydrogen injection along the tubular reactor and molar ratio of comonomer.

The polymer solution (after the reaction) is heated between the range of 285˜300° C. in order to avoid phase separation in the adsorber beds whose function is to remove catalyst residues. In order for the catalyst to be removed, it may be previously deactivated by deactivators.

After the adsorber vessels, the solution goes to the separators where all the hydrocarbons (solvent, monomer and comonomer) are separated and sent to the distillation area to be purified and separated.

Other embodiments may use slurry polymerization that, unlike solution polymerization where the polymer remains dissolved, the resulting polymer is suspended in the liquid medium without dissolving. Slurry polymerizations may include loop reactors, stirred tank reactors, and tubular reactors. Olefin monomers like ethylene and optionally one or more alpha olefin comonomer(s) are polymerized in a in a hydrocarbon diluent, such as propane or isobutane, in the presence of a polymerization catalyst, and optionally in the presence of hydrogen at elevated pressure and temperature. The temperature in the loop may range from about 60° C. to about 110° C. and optionally at supercritical conditions, where the operating temperature exceeds the critical temperature of the reaction mixture, and the operating pressure exceeds the critical pressure of the reaction mixture. At such conditions, the operation temperature may be higher than 90° C.

The operating pressure may be selected so that the contents of the reactor remain either in liquid state or supercritical state. For liquid slurry operation, the suitable range of operating pressure may range from about 20 to about 100 bar, and for supercritical slurry operation, the suitable range of operating pressure may range from about 50 to about 100 bar. The slurry is withdrawn from the reactor and concentrated, such as in a hydrocyclone or in settling legs for loop reactors, so that the solids content at the reactor outlet is higher than the solids content in the reactor. The concentrated slurry may be conveyed to a flash unit for essentially evaporating all of the remaining liquid-phase hydrocarbons of the slurry phase diluent.

In gas phase polymerizations, most of the reaction fluid in the reactor is in the gaseous state and the polymer is in particulate form. Such reactors may include, for example, a gas-phase fluidized-bed reactor or a stirred bed reactor. In such reactors, a bed of polymer is formed in the presence of a polymerization catalyst. A gas phase reactor may be operated at a temperature ranging from about 60° C. to about 115° C., and at an operating pressure ranging from 10 to 30 bar.

In a fluidized bed gas phase reactor, an olefin is polymerized in the presence of a polymerization catalyst in an upwards moving gas stream. The reactor typically contains a fluidized bed comprising the growing polymer particles containing the active catalyst located above a fluidization grid. When the fluidization gas is contacted with the bed containing the active catalyst, the reactive components of the gas, such as monomers and chain transfer agents, react in the presence of the catalyst to produce the polymer product.

### Secondary Polyolefins

In one or more embodiments, the secondary polyolefins according to the present disclosure are selected from ethylene-based polymers. The secondary ethylene-based polymers according to the present disclosure may include high density polyethylenes (HDPE), very low density polyethylenes (VLDPE), low density polyethylenes (LDPE), linear low density polyethylenes (LLDPE) or ethylene-vinyl acetate copolymers (EVA). In a preferred embodiment, the secondary ethylene-based polymers are selected from LDPE, LLDPE or EVA, more preferably from EVA or LLDPE, even more preferably from LLDPE.

The secondary ethylene-based polymers are selected from secondary ethylene-based homopolymers, secondary ethylene-based copolymers or ethylene-vinyl acetate (EVA) copolymers. In one or more embodiments, the secondary ethylene-based copolymers are selected from ethylene-based copolymers of ethylene with one or more C3-C10 alpha olefin comonomers, such as ethylene with one C3-C10 alpha olefin comonomer. Preferably, the one or more C3-C10 alpha olefin comonomers are selected from 1-propene, 1-butene, 1-pentene, 1-hexene, 1-heptene, 1-octene, 1-nonene, 1-decene or mixtures thereof, more preferably 1-butene, 1-hexene, or mixtures thereof. In particular embodiments, the secondary ethylene-based copolymers may include one or more C4-C8 alpha olefin comonomers, preferably selected from 1-butene, 1-pentene, 1-hexene, 1-heptene, 1-octene or mixtures thereof, more preferably 1-butene, 1-hexene or mixtures thereof.

In more particular embodiments, the secondary ethylene-based polymers are selected from secondary ethylene-based homopolymers, secondary ethylene-based copolymers of ethylene with 1-butene, secondary ethylene-based copolymers of ethylene with 1-hexene or EVA copolymers. In even more particular embodiments, the secondary ethylene-based polymers are selected from secondary ethylene-based copolymers of ethylene with 1-butene, secondary ethylene-based copolymers of ethylene with 1-hexene or EVA copolymers.

In some embodiments, the secondary ethylene-based polymer may have an ethylene content ranging from a lower limit selected from one of 51 mol %, 60 mol %, 70 mol %, 80 mol %, 82 mol %, 84 mol %, 86 mol %, 88 mol %, 90 mol %, 91 mol %, 92 mol %, 93 mol %, 94 mol %, 95 mol %, to an upper limit selected from 70 mol %, 80 mol %, 82 mol %, 84 mol %, 86 mol %, 88 mol %, 90 mol %, 91 mol %, 92 mol %, 93 mol %, 94 mol %, 95 mol %, 96 mol %, 97 mol %, 98 mol %, 99 mol %, 99.5 mol %, 99.9 mol %, 100 mol % of the total number of moles of the secondary ethylene-based polymer, where any lower limit may be paired with any upper limit, when feasible.

In one or more embodiments, the secondary ethylene-based copolymer may have a content of one or more C3-C10 alpha olefin comonomers ranging from a lower limit selected from one of 0.1 mol %, 0.5 mol %, 1.0 mol %, 2.0 mol %, 3.0 mol %, 4.0 mol %, 5.0 mol %, 6.0 mol %, 7.0 mol %, 8.0 mol %, 9.0 mol %, 10 mol %, 12 mol %, 14 mol %, 16 mol %, 18 mol %, 20 mol %, 30 mol % to an upper limit selected from one of 5 mol %, 6 mol % 7 mol %, 8 mol %, 9 mol %, 10 mol %, 12 mol %, 14 mol %, 16 mol %, 18 mol %, 20 mol %, 30 mol %, 40 mol %, and 49 mol % of the total number of moles of the primary ethylene-based copolymer, where any lower limit may be paired with any upper limit, when feasible. Comonomer content can be measured by NMR spectroscopy.

In one or more embodiments, a stress exponent (SEx) of the secondary ethylene-based polymer may be calculated using equations I and II. In some embodiments, the ethylene-based polymer of the adhesion layer may have an SEx ranging from a lower limit selected from 1.0, 1.1, 1.2, 1.23, and 1.27 to an upper limit selected from 1.37, 1.4, 1.5, 1.6, 1.8, 2.0, 2.5, 2.8 and 3.0 where any lower limit may be paired with any upper limit.

In one or more embodiments, the secondary ethylene-based polymer may have a Mw, measured by GPC, ranging from 50,000 g/mol to 600,000 g/mol. For example, the Mw may range from a lower limit of any of 50,000 g/mol, 60,000 g/mol, 65,000 g/mol, 70,000 g/mol, 75,000 g/mol, 80,000 g/mol, 85,000 g/mol, 90,000 g/mol, 100,000 g/mol and 110,000 g/mol, and an upper limit of any of 100,000 g/mol, 110,000 g/mol, 115,000 g/mol, 120,000 g/mol, 125,000 g/mol, 150,000 g/mol, 175,000 g/mol, 200,000 g/mol, 300,000 g/mol, 400,000 g/mol, 500,000 g/mol and 600,000 g/mol, where any lower limit can be used in combination with any upper limit, when feasible.

In one or more embodiments, the secondary ethylene-based polymer may have a Mn, measured by GPC, ranging from 4,000 g/mol to 50,000 g/mol. For example, the Mn may range from a lower limit of any of 4,000 g/mol, 6,000 g/mol, 10,000 g/mol and 12,000 g/mol, to an upper limit of any of 12,000, 15,000 g/mol, 18,000 g/mol, 20,000 g/mol, 22,000 g/mol, 25,000 g/mol, 30,000 g/mol, 35,000 g/mol, 40,000 g/mol, 45,000 g/mol and 50,000 g/mol, where any lower limit can be used in combination with any upper limit, when feasible.

In one or more embodiments, the secondary ethylene-based polymer may have a Mz, measured by GPC, ranging from 100,000 g/mol to 5,000,000 g/mol. For example, the Mz may range from a lower limit of any of 100,000 g/mol, 125,000 g/mol, 150,000 g/mol, 180,000 g/mol, 200,000 g/mol, 250,000 g/mol, 290,000 g/mol to an upper limit of any of 300,000 g/mol, 350,000 g/mol, 370,000 g/mol, 400,000 g/mol, 450,000 g/mol, 500,000 g/mol, 550,000 g/mol, 600,000 g/mol, 650,000 g/mol, 675,000 g/mol, 700,000 g/mol, 725,000 g/mol, 1,000,000 g/mol, 2,000,000 g/mol, 3,000,000 g/mol, 4,000,000 g/mol and 5,000,000 g/mol, where any lower limit can be used in combination with any upper limit.

In one or more embodiments, secondary ethylene-based polymer may have an MWD, or Mw/Mn, ranging from a lower limit selected from 2, 3, 4, 5, 6, 8 and 10 to an upper limit selected from 6, 7, 8, 9, 10, 12, 15, 20, 30, 40 and 50, where any lower limit may be paired with any upper limit, when feasible.

In one or more embodiments, the secondary ethylene-based polymer may have a density, according to ASTM D792, ranging from a lower limit selected from one of 890 kg/m³, 900 kg/m³, 910 kg/m³, 915 kg/m³, 920 kg/m³, 925 kg/m³, 930 kg/m³, 935 kg/m³ and 940 kg/m³ to an upper limit selected from 935 kg/m³, 940 kg/m³ 945 kg/m³, 950 kg/m³ and 951 kg/m³, 952 kg/m³, 953 kg/m³, 955 kg/m³, 960 kg/m³ and 961 kg/m³, where any lower limit may be paired with any upper limit.

In one or more embodiments, the secondary ethylene-based polymer may have an MFR₂, according to ASTM D1238 at 190° C./2.16 kg, ranging from a lower limit selected from any one of 0.5 g/10 min, 0.6 g/10 min, 0.7 g/10 min, 0.8 g/10 min, 0.9 g/10 min, 1.0 g/10 min, 1.5 g/10 min, 1.8 g/10 min, 2.0 g/10 min, 2.4 g/10 min, 2.5 g/10 min, 5.0 g/10 min, 7.0 g/10 min and 7.1 g/10 min to an upper limit selected from any one of 2.5 g/10 min, 2.6 g/10 min, 2.7 g/10 min, 2.8 g/10 min, 2.9 g/10 min, 3.0 g/10 min, 5.0 g/10 min, 6.0 g/10 min, 7.0 g/10 min, 8 g/10 min, 9 g/10 min, 9.5 g/10 min, 10 g/10 min, 15 g/10 min, 20 g/10 min, 25 g/10 min and 30 g/10 min, where any lower limit may be paired with any upper limit, when feasible.

In one or more embodiments, the secondary ethylene-based polymer may have a melt temperature I according to ASTM 3418 ranging from a lower limit selected from 95° C., 98° C., 100° C., 105° C., 107° C., 110° C., 111° C., 112° C., 113° C., 114° C., 115° C., 116° C., 117° C., 118° C., 119° C. and 120° C. to an upper limit selected from 120° C., 123° C., 125° C., 130° C., 131° C., 132° C., 133° C., 134° C., 135° C., 136° C., 137° C., 138° C., 139° C. and 140° C., where any lower limit may be paired with any upper limit.

In one or more embodiments, the secondary ethylene-based polymer may have a crystallization temperature (Tc) according to ASTM 3418 ranging from a lower limit selected from any one of 45° C., 50° C., 55° C., 60° C. and 65° C., 70° C., 75° C. to an upper limit selected from any one of 70° C., 75° C., 80° C., 85° C., 90° C., 95° C., 100° C., 105° C., 110° C., 115° C., 120° C., and 125° C., where any lower limit may be paired with any upper limit, when feasible.

In one or more embodiments, the secondary ethylene-based polymer of the adhesion layer may have a complex viscosity at 0.09 rad/s ranging from 1,000 to 25,000 Pa·.

In one or more embodiments, the secondary ethylene-based polymer may have a complex viscosity at 300 rad/s ranging from 100 to 2,000 Pa·s.

In one or more embodiments, the secondary ethylene-based polymer may have a shear thinning index SHI_{5/200}, being the ratio of the complex shear modulus at 5 kPa to the complex shear modulus at 200 kPa, of from 2 to 18.

In one or more embodiments, the secondary ethylene-based polymer may have a shear thinning index SHI_{2.7/210}, being the ratio of the complex shear modulus at 2.7 kPa to the complex shear modulus at 210 kPa, of from 2 to 26.

In one or more embodiments, the secondary ethylene-based polymer may have an elasticity balance tan 0.09/tan 300, being the ratio of the loss tangent at 0.09 rad/s to the loss tangent at 300 rad/s of from 1 to 26.

In one or more embodiments, the secondary ethylene-based polymer may contain a number of functional additives that modify various properties of the polymer. Such additives may include antioxidants, acid scavengers, pigments, fillers, reinforcements, adhesion-promoting agents, biocides, whitening agents, nucleating agents, slip agents, anti-statics, anti-blocking agents, processing aids, flame-retardants, plasticizers, light stabilizers, UV stabilizers and the like.

In some embodiments, the secondary ethylene-based polymer may have an additive content ranging from a lower limit selected from 0 wt %, 1 wt %, and 2 wt % to an upper limit selected from 3 wt %, 4 wt %, and 5 wt % based on the total weight of the secondary ethylene-based polymer, where any lower limit may be paired with any upper limit.

In more particular embodiments, the secondary ethylene-based polymer is selected from LLDPE produced from a metallocene catalyst, or a Ziegler-Natta catalyst or LDPE produced in autoclave or tubular high pressure polymerization. Examples of suitable secondary ethylene-based polymer suitable for the present disclosure are polyethylenes commercialized by Braskem including, but not limited to LLDPE such as Proxess3310, Proxess2606, FP33, LF320 among other LLDPEs and LDPE such as TS9022 and BC818, among other LDPEs.

In particular embodiments, the secondary ethylene-based polymer is selected from copolymers of ethylene with vinyl acetate (EVA) copolymer. The EVA copolymers according to the present disclosure may incorporate various ratios of ethylene and vinyl acetate. In one or more embodiments, the weight percentage (wt %) of ethylene in the EVA copolymers ranges from a selected lower limit to from any of 40 wt %, 45 wt %, 50 wt %, 55 wt %, 60 wt %, 65 wt %, 70 wt %, 72 wt %, to an upper limit selected from any of 65 wt %, 72 wt %, 74 wt %, 80 wt %, 83 wt %, 84 wt %, 88 wt %, 90 wt %, 92 wt %, 93 wt %, 94 wt %, 95 wt %, where any lower limit can be paired with any upper limit, when feasible.

In particular embodiments, the EVA copolymer according to the present disclosure may include a percent by weight (wt %) of vinyl acetate as determined by ASTM D5594 that ranges from a lower limit selected from any one of 5 wt %, 6 wt %, 7 wt %, 8 wt %, 10 wt %, 12 wt %, 16 wt %, 17 wt %, 20 wt %, 26 wt %, 28 wt %, and 35 wt %, to an upper limit selected from any one of 28 wt %, 30 wt %, 35 wt %, 40 wt %, 45 wt %, 50 wt %, 55 wt % and 60 wt %, where any lower limit may be paired with any upper limit.

In particular embodiments, the EVA copolymer according to the present disclosure exhibits a melt index (12) as determined by ASTM D1238 as measured with a load of 2.16 kg at 190° C. that ranges from a lower limit of any of 1.5 g/10 min, 1.8 g/10 min, 2.0 g/10 min, 2.3 g/10 min, 2.5 g/10 min, 3.0 g/10 min, 3.5 g/10 min, 4.0 g/10 min, 4.5 g/10 min, 5 g/10 min, 5.5g/10 min, 6.0g/10 min, 10 g/10 min, 15g/10 min, 25 g/10 min, 50 g/10 min, 100 g/10 min, and 150 g/10 min to an upper limit of any of 10 g/10 min, 20 g/10 min, 25 g/10 min, 40 g/10 min, 50 g/10 min, 100 g/10 min, 200 g/10 min, 400g/10 min, 500 g/10 min, 800 g/10 min, and 900 g/10 min, where any lower limit may be paired with any upper limit, when feasible.

The EVA copolymer in accordance with the present disclosure may have a density as determined by ASTM D1505/D792 that may range of a lower limit selected from any one of 0.91 g/cm³, 0.915 g/cm³, 0.92 g/cm³, 0.925 g/cm³, 0.93 g/cm³, 0.935 g/cm³, 0.94 g/cm³, 0.945 g/cm³ to an upper limit selected from any one of 0.95 g/cm³, 0.955 g/cm³, 0.96 g/cm³, 0.965 g/cm³ or 0.97 g/cm³, where any lower limit can be used with any upper limit.

In particular embodiments, the EVA copolymer may be derived from renewable sources such as biobased EVA, which may be used alone or in combination with EVA copolymer derived from fossil sources. EVA copolymer according to the present disclosure may have a biobased carbon content determined by ASTM D6866 that ranges from a selected lower limit of any of 5%, 10%, 20%, 40%, and 55%, to an upper limit selected from any of 60% by weight, 80% by weight, 95% by weight, and 99% by weight, where any lower limit may be paired with any upper limit. The total biobased or renewable carbon in the EVA polymer can be contributed from a biobased ethylene and/or a biobased vinyl acetate. It is understood that if at least a portion of the ethylene and/or vinyl acetate is derived from a renewable source, it can be considered a biobased EVA, even if a fossil-based ethylene and/or vinyl acetate is present in the polymerization process.

Renewable carbon sources for ethylene and vinyl acetate used to produce biobased EVA copolymers may include plant-based sources such as sugar cane and sugar beet, maple, date palm, sugar palm, sorghum, American agave, corn, wheat, barley, sorghum, rice, potato, cassava, sweet potato, seaweed, fruit, materials comprising cellulose, wine, materials comprising hemicelluloses, materials comprising lignin, wood, straw, sugarcane bagasse, sugarcane leaves, corn stove, wood waste, paper, and their combinations. Biobased vinyl acetate can be produced by producing acetic acid by oxidizing bioethanol (which can be formed as described above) followed by reacting ethylene and acetic acid with ethylene acyloxylate to vinyl acetate. Furthermore, it is understood that ethylene reacted with acetic acid can also be formed from a renewable source, as described above. Additional details on the oxidation of ethanol to acetic acid can be found in US Pat. No. 5,840,971 and on the selective catalytic oxidation of ethanol to acetic acid in dispersed Mo-V-Nb mixed oxides. Li X, Iglesia E. Chemistry; 2007;13(33):9324-30.

Vinyl acetate according to the present disclosure can also be generated by the esterification of acetic acid obtained from various natural sources, including fatty acid conversion, as described in The Production of Vinyl Acetate Monomer as a Co-Product from the Non-Catalytic Cracking of Soybean Oil, Benjamin Jones, Michael Linnen, Brian Tande and Wayne Seames, Processes, 2015, 3, 61-9-633. Furthermore, the production of acetic acid from fermentation carried out by acetogenic bacteria, as described in acetic acid bacteria: A group of bacteria with versatile biotechnological applications, Saichana N, Matsushita K, Adachi O, Frébort I, Frebortova J .; Biotechnol Adv. 2015 Nov 1;33(6 Pt 2):1260-71, and biotechnological applications of acetic acid bacteria. Raspor P, Goranovic D. Criteria Rev Biotechnol .; 2008; 28(2): 101-24.

Examples of suitable secondary ethylene-based copolymers suitable for the present disclosure are EVAs commercialized by Braskem including, but not limited to HM728F and TN2020.

In one or more embodiments, the ethylene-based polymer of the adhesion layer be selected from LDPE, LLDPE or EVA, preferably LLDPE or EVA, even more preferably from LLDPE.

The secondary ethylene-based polymer may also include ethylene-based elastomers and ethylene-based plastomers. In some embodiments, the secondary ethylene-based polymer may contain one or more polyolefins that are previously processed polymers. “Previously processed polymers” refer to as polymers that have previously been used and may include blends or coextruded formulations for reprocessed films, regrinds, post-consumer resins, post-industrial resins, and the like.

### Polymer Substrate—First Polyolefin-Based Layer

In one or more embodiments, the polymer substrate of the present disclosure comprises a first polyolefin-based layer. The first polyolefin-based layer may comprise a primary olefin according to the present disclosure, a secondary polyolefin of the present disclosure, or a mixture of a primary olefin with a secondary polyolefin. Preferably, the first polyolefin-based layer comprises a primary polyolefin according to the present disclosure, or a mixture of a primary polyolefin with a secondary polyolefin according to the present disclosure.

In one or more embodiments, the first polyolefin-based layer comprises a content of a primary ethylene-based polymer ranging from a lower limit selected from 30 wt %, 40 wt %, 50 wt %, 60 wt %, 70 wt % and 75 wt % to an upper limit selected from 75 wt %, 80 wt %, 85 wt %, 90 wt %, 95 wt % and 100 wt % based on the total weight of the first polyolefin-based layer, where any lower limit may be paired with any upper limit, when feasible.

In one or more embodiments, the first polyolefin-based layer may comprise a secondary ethylene-based polymer in an amount ranging from a lower limit selected from 0 wt %, 5 wt % 10 wt %, 15 wt %, 20 wt % and 25 wt % to an upper limit selected from 25 wt %, 30 wt %, 40 wt % and 50 wt %, 60 wt % and 70 wt. %, based on the total weight of the first polyolefin-based layer, where any lower limit may be paired with any upper limit, when feasible.

### Polymer Substrate—Adhesion Layer

In one or more embodiments, the polymer substrate of the present disclosure comprises an adhesion layer on at least one surface of the first polyolefin-based layer. The adhesion layer may confer better adhesion between the coating layer and the side of the polymer substrate whereon the coating layer is applied.

For the purposes of the present disclosure, the term “at least one surface of the first polyolefin-based layer” means that the adhesion layer may be applied by lamination or coextruded facing the external side of the first polyolefin-based layer in a partial or complete manner. Generally, for the purposes of the present disclosure, the “external side” is to be understood as the side of substrate or layer faced or directed to the external environment when the coated polymeric article is used as a packaging material. The “internal side” is to be understood as the side of substrate or layer faced or directed to the internal surface of the packaging when the coated polymeric article is used as a packaging material.

The external side of the adhesion layer may be understood as the external side of the polymer substrate. The internal side of the adhesion layer faces the first polyolefin-based layer. The external side of the first polyolefin-based layer is to be understood as the side of the first polyolefin-based layer that faces the adhesion layer.

In embodiments in which the polymer substrate comprises more than one polyolefin-based layer, the internal side of the first polyolefin-based layer is to be understood as the side of the first polyolefin-based layer that faces the second polyolefin-based layer. Analogously, the internal side of the polymer substrate is to be understood as the side of the last polyolefin-based layer that does not face the penultimate polyolefin-based layer.

The adhesion layer may comprise the primary olefin according to the present disclosure, the secondary polyolefins of the present disclosure, or a mixture of the primary olefin and secondary polyolefins of the present disclosure. Preferably, the adhesion layer comprises one or more secondary polyolefins according to the present disclosure, or a mixture of one or more secondary polyolefin with a primary polyolefin according to the present disclosure. In one or more embodiments, the adhesion layer comprises a secondary polyolefin according to the present disclosure, or a mixture of a secondary polyolefin with a primary polyolefin according to the present disclosure.

In one or more embodiments, the adhesion layer comprises a content of one or more secondary ethylene-based polymers ranging from a lower limit selected from 30 wt %, 40 wt %, 50 wt %, 60 wt %, 70 wt % and 75 wt % to an upper limit selected from 75 wt %, 80 wt %, 85 wt %, 90 wt %, 95 wt % and 100 wt % based on the total weight of the adhesion layer, where any lower limit may be paired with any upper limit, when feasible.

In one or more embodiments, the adhesion layer may comprise a primary ethylene-based polymers in an amount ranging from a lower limit selected from 0 wt %, 5 wt %, 10 wt %, 15 wt %, 20 wt % and 25 wt % to an upper limit selected from 25 wt %, 30 wt %, 40 wt % and 50 wt %, 60 wt % and 70 wt %, based on the total weight of the adhesion layer, where any lower limit may be paired with any upper limit, when feasible.

In one or more embodiments, the adhesion layer comprises a mixture of two secondary polyolefins of the present disclosure, preferably a mixture of a secondary ethylene-based copolymer and an EVA copolymer. In preferred embodiments, the adhesion layer comprises from 10 wt % to 90 wt % of a secondary ethylene-based copolymer and 10 wt % to 90 wt % of an EVA copolymer, based on the total weight of the adhesion layer.

### Polymer Substrate—Additional Polyolefin-Based Layers

In one or more embodiments, the polymer substrate may comprise more than one polyolefin-based layers, for example, a second polyolefin-based layer. In the context of the present disclosure, the term “second polyolefin-based layer” is to be understood as a consecutive layer to the first polyolefin-based layer, being possible to have an adhesive layer between them if the layers are laminated over each other. In other words, the second polyolefin-based layer is applied by lamination or coextruded facing the side of the polyolefin-based layer that it is opposed to the adhesion layer. The polyolefin of the second polyolefin-based layer may be selected from the polyolefin according to the first polyolefin-based layer of present disclosure described in the previous paragraphs, in a way that the constitutive descriptions of the first polyolefin-based layer of the previous paragraphs also applies to the second polyolefin-based layer. The polyolefin of the second polyolefin-based layer may also be selected from the polyolefins of the adhesion layer described in the previous paragraphs, in a way that the constitutive description of the adhesion layer of the previous paragraphs also applies to the second polyolefin-based layer. The polyolefin or polyolefins of each layer of the coated article of the present disclosure may be independently selected layer by layer.

In a preferred embodiment, the second polyolefin-based layer comprises one or more secondary polyolefins according to the present disclosure, or a mixture of one or more secondary polyolefins with a primary polyolefins according to the present disclosure. In more preferred embodiments, the second polyolefin-based layer comprises one or more secondary polyolefin according to the present disclosure, or a mixture of a secondary polyolefin with a primary polyolefin according to the present disclosure.

In one or more embodiments, the second polyolefin-based layer comprises a content of one or more secondary ethylene-based polymers ranging from a lower limit selected from 40 wt %, 50 wt %, 60 wt %, 70 wt % and 75 wt % to an upper limit selected from 75 wt %, 80 wt %, 85 wt %, 90 wt % and 100 wt % based on the total weight of the second polyolefin-based layer, where any lower limit may be paired with any upper limit, when feasible.

In one or more embodiments, the second polyolefin-based layer may comprise a primary ethylene-based polymers in an amount ranging from a lower limit selected from 0 wt %, 10 wt %, 15 wt %, 20 wt % and 25 wt % to an upper limit selected from 25 wt %, 30 wt %, 40 wt % and 50 wt % and 60 wt % based on the total weight of the second polyolefin-based layer, where any lower limit may be paired with any upper limit, when feasible.

In one or more embodiments, the second polyolefin-based layer comprises a mixture of two secondary polyolefins of the present disclosure, preferably a mixture of a secondary ethylene-based copolymer and an EVA copolymer. In preferred embodiments, the second polyolefin-based layer comprises from 10 wt % to 90 wt % of a secondary ethylene-based copolymer and 10 wt % to 90 wt % of an EVA copolymer, based on the total weight of the second polyolefin-based layer.

In one or more embodiments, the polymer substrate may comprise more than two polyolefin-based layers, for example, a third, a fourth, a fifth, a sixth, a seventh, an eighth, a ninth, a tenth, or even more layers.

In the context of the present disclosure, the term “third polyolefin-based layer” is to be understood as a consecutive layer to the second polyolefin-based layer, being possible to have an adhesive layer between consecutive layers, particularly if the layers are laminated over each other. In other words, the third polyolefin-based layer is applied by lamination or coextruded facing the side of the second polyolefin-based layer that it is opposed to the first polyolefin-based layer. The term “fourth polyolefin-based layer” is to be understood as a consecutive layer to the third polyolefin-based layer, being possible to have an adhesive layer between consecutive layers, particularly if the layers are laminated over each other. In other words, the fourth polyolefin-based layer is applied by lamination or coextruded facing the side of the third polyolefin-based layer that it is opposed to the second polyolefin-based layer. Analogous definitions are applied to the fifth, sixth, seventh, eighth, ninth, tenth, or superior layers.

The polyolefins of the third, fourth, fifth, sixth, seventh, eighth, ninth, tenth and/or superior polyolefin-based layers may be selected from the polyolefins according to the first polyolefin-based layer or second polyolefin-based layers of present disclosure described in the previous paragraphs, in a way that the constitutive descriptions of the first polyolefin-based layer and second polyolefin-based layers of the previous paragraphs also applies to the polyolefin of the third, fourth, fifth, sixth, seventh, eighth, ninth, tenth and/or superior polyolefin-based layers. The composition of the third, fourth, fifth, sixth, seventh, eighth, ninth, tenth and/or superior polyolefin-based layers are independently selected from each other.

### Coating Layer

In one or more embodiments, the coated polymeric multilayer article according to the present disclosure comprise a coating layer on at least one surface of the adhesion layer. The coating layer of the present disclosure is not particularly limited. Suitable coating layers may be applied as long as it enhances the barrier properties of the coated polymeric multilayer article.

For the purposes of the present disclosure, the term “at least one surface of the adhesion layer” means that the coating layer may be applied in a partial or complete manner on the external side of the adhesion layer. The “external side” of the coating layer is the side that does not face the adhesion layer. The “internal side” of the coating is to be understood as the side of the adhesion layer that faces the adhesion layer.

In one or more embodiments, the coating layer of the present disclosure includes inorganic materials exfoliated and/or dispersed in a polymer matrix. There is no restriction on the type of inorganic materials in this invention provided that is dispersible in a polymer matrix that is an intercalated or exfoliated (aspect ratios greater than 20) during the preparation of the coating, preferably in the form of phyllosilicates. Inorganic materials may include clays such as vermiculite, hectorite, sodium terasililic mica, montmorillonite, bentonite, sodium silicate, magnesium aluminum silicate, sodium tainiolite and organically modified silicate dispersed in a solvent in which the polymer is also soluble. In preferred embodiments the inorganic material includes any phyllosilicate. Methods for preparing vermiculite suitable for the present disclosure are described in U.S. Pat. Nos. 3,325,340; 4,885,330; 5,102,464; and 5,326,500, incorporated herein by reference.

In one or more embodiments, the polymer matrix of the coating layer forms films, herein named as “film polymers”. Film polymers according to the present disclosure include polyhydroxy polymers, urethane polymers, rubber, acrylate polymers and polyesters. Preferred embodiments include polyhydroxy polymers such as ethylene vinyl alcohol (EVOH) or polyvinyl alcohol (PVOH).

The coating composition according to the present disclosure may also comprise cross-linking agents and stabilizers. Cross-linking agents may include glyoxal or glyoxal condensates such as cyclic urea glyoxal condensate.

Preferred stabilizers for the inorganic compounds are those bearing a positive charge, for example, having an ammonium group, amino carboxylic acids, amines and ammonia. Compounds bearing lithium cations are also suitable as stabilizers.

In one or more embodiments, the coating layer of the present disclosure may have a thickness that may range of a lower limit selected from any one of 0.10 micra, 0.20 micra, 0.30 micra or 0.40 micra to an upper limit selected from any one of 0.35 micra, 0.40 micra, 0.50 micra, 0.60 micra, 0.70 micra, 0.80 mica, 0.90 micra or 1.00 micra, where any lower limit can be used with any upper limit.

### Sealing Film

In one or more embodiments, a sealing film is applied over the coated polymeric multilayer article after the article is formed, resulting in a sealed coated polymeric multilayer article. The term “coated polymeric multilayer article” as used in the present disclosure also refers to the sealed coated polymeric multilayer article if the sealing film is present. The sealing film may be applied over the coating layer in order to protect it from the external environment or from the handling of the article during the production of the film or package, also protecting the coating layer from the handling of the consumer. The sealing film may also be referred as “superior film”. The sealing film may be applied, for example, using lamination processes known in the art, wherein adhesive layers may be applied to promote adhesion between the sealing film and the coated polymeric multilayer article.

The polymers or polyolefins of the sealing film are not particularly limited as long as it protects the coating layer. The higher amorphicity of the polyolefins composing the sealing film promotes higher sealing of the coating. In one or more embodiments, the sealing film includes high density polyethylene (HDPE), very low density polyethylene (VLDPE), low density polyethylene (LDPE), linear low density polyethylene (LLDPE) or ethylene-vinyl acetate copolymer (EVA), and mixtures thereof. More preferably, the sealing film includes very low density polyethylene (VLDPE), low density polyethylene (LDPE), linear low density polyethylene (LLDPE), or mixtures thereof.

In one or more embodiments, the sealing film may comprise the primary olefin according to the present disclosure, the secondary polyolefin of the present disclosure, or mixtures thereof. The sealing film may comprise one or more secondary polyolefins according to the present disclosure, or a mixture of one or more secondary polyolefins with one or more primary polyolefins according to the present disclosure. In more preferred embodiments, the sealing film comprises a secondary polyolefin according to the present disclosure, or a mixture of a secondary polyolefin with a primary polyolefin according to the present disclosure.

In one or more embodiments, the sealing film comprise a content of one or more secondary ethylene-based polymers ranging from a lower limit selected from 30 wt %, 40 wt %, 50 wt %, 60 wt %, 70 wt % and 75 wt % to an upper limit selected from 75 wt %, 80 wt %, 85 wt %, 90 wt % and 100 wt % based on the total weight of the first polyolefin-based layer, where any lower limit may be paired with any upper limit, when feasible.

In one or more embodiments, the sealing film may comprise one or more primary ethylene-based polymers in an amount ranging from a lower limit selected from 0 wt %, 10 wt %, 15 wt %, 20 wt % and 25 wt % to an upper limit selected from 25 wt %, 30 wt %, 40 wt % and 50 wt %, 60 wt % and 70 wt %, based on the total weight of the first polyolefin-based layer, where any lower limit may be paired with any upper limit, when feasible.

### Recyclability

In one or more embodiments, the coated polymeric multilayer article according to the present disclosure may be designed to have improved recyclability. In order to achieve improved recyclability, the layers of the article have as less types of materials as possible.

In a preferred embodiment, the article or the layers of the article according to the present disclosure are made of two types of material (bimaterial article or film), or of a single type of material (monomaterial article or film). For the sake of recycling standards, the term “made of” in the context of recyclability refers to at least 90% by weight of the constitution of the article, based on the total weight of the coated polymeric multilayer article. Hence, the coated polymeric multilayer article according to the present disclosure may comprise at least 90% by weight, at least 91% by weight, at least 92% by weight, at least 93% by weight, at least 94% by weight, at least 95% by weight, at least 96% by weight, at least 97% by weight, at least 98% by weight, at least 99% by weight, at least 99.9% by weight, based on the total weight of the coated polymeric multilayer article, of two types of material or of a single type of material.

For the purposes of the present disclosure, the term “type of material” relates to the types of monomers and comonomers constituting the polyolefins of the coated polymeric multilayer article. For example, ethylene-based homopolymers and ethylene-based copolymers produced from one or more ethylene and one or more C3-C10 alpha olefin comonomers constitute, together, a single type of material. Ethylene-vinyl acetate (EVA) copolymers constitute another type of material. Propylene-based polymers constitute another type of material.

### Optional Layers

The coated article of the present disclosure may also comprise optional layers between the polyolefin-based layers, or even between the first polyolefin-based layer and adhesion layer. In one or more embodiments, optional layers may be barrier layers with the purpose of increasing the barrier properties of the coated polymeric multilayer article. The barrier layers are applied using usual methods known in the art.

In one or more embodiments, it is also possible to apply ink and/or varnish layers over the coated polymeric multilayer article so as to print colors, images, and text on the coated polymeric multilayer article. It is also possible to apply protective layers over the ink and/or varnish layers to preserve the printed surface. The ink and/or varnish and protective layers are applied using usual methods known in the art.

In one or more embodiments, coated article of the present disclosure may also comprise a primer layer applied between the adhesion layer and coating layer. The primer layer may improve the adhesion between the adhesion layer and the coating. The primer may comprise water-based cationic copolymers, anionic copolymers, modified polyolefins, preferably, polyolefins comprising polar groups (e.g. polyolefins modified with maleic anhydride), acrylates, among others suitable for polyolefin extrusion coating. In a preferred embodiment, the coated article does not comprise the primer layer between the adhesion layer and the coating.

### Films and Film Properties

The coated polymeric multilayer article according to the present disclosure may be particularly suitable for being used as various articles, including but not limited to coated multilayer polymeric films. In one or more embodiments, the coated polymeric multilayer article is a coated blown film, coated cast film, coated mono-oriented film or coated biaxially oriented film. In preferred embodiments, the coated polymeric multilayer article may be a coated biaxially oriented film. It is also envisioned that the coated films described herein can be used a range of applications, where good barrier properties are an advantage, as well as any other uses known to those of ordinary skill in the art for polyolefin films, particularly polyethylene films. In a preferred embodiment, the coated polymeric multilayer article according to the present disclosure is used as a packaging material.

In one or more embodiments, the coated polymeric multilayer article is a coated biaxially oriented film.

In one or more embodiments, films of the present disclosure may have a haze of 95% or lower, according to ASTM 1003D, when a thickness of the biaxially oriented film is 20 μm . More particular embodiments may have a haze of 85% or less, 75% or less, 65% or less, 50% or less, 45% or less, 40% or less, 30% or less, 20% or less, 15% or less, 10% or less, or 5% or less.

In one or more embodiments, films of the present disclosure may have a gloss at 45° of 5 g.u. or higher, according to ASTM D2457, such as 10 g.u. or higher, 20 g.u. or higher, 30 g.u. or higher, 40 g.u. or higher, 50 g.u. or higher, 60 g.u. or higher, 70 g.u. or higher or 75 g.u. or higher.

In one or more embodiments, films of the present disclosure may have a tensile modulus of 1000 MPa or higher, according to ASTM D882, in a machine direction of the biaxially oriented film, such as 1050 MPa or higher, 1100 MPa or higher, as 1200 MPa or higher, 1300 MPa or higher or 1400 MPa or higher.

In one or more embodiments, films of the present disclosure may have a tensile modulus of 1000 MPa or higher according to ASTM D882 in a transverse direction of the biaxially oriented film, such as 1050 MPa or higher, 1100 MPa or higher, as 1200 MPa or higher, 1300 MPa or higher or 1400 MPa or higher, 1500 MPa or higher, 1700 MPa or higher or 2000 MPa or higher.

In one or more embodiments, films of the present disclosure may have a roughness (Ra) ranging from 20 nm to 500 nm, according to ISO 4287: 1997 measured by Atomic Force Microscopy (AFM). In one or more embodiments, films may have a roughness (Ra) ranging from a lower limit selected from 20 nm, 30 nm, 40 nm, 50 nm, 100 nm, 150 nm and 200 nm to an upper limit selected from 50 nm, 150 nm, 200 nm, 300 nm, 400 nm and 500 nm, where any lower limit may be paired with any upper limit.

In one or more embodiments, the coated multilayer films may be formed to have a maximum thickness of about 8 mil or less, or 5 mil or less, or 3 mil or less or more specifically, 1 mil or less or 0.5 mil or less in more particular embodiments. For example, in one or more embodiments, the adhesion layer may have a thickness less than 0.2 mil, such as in a range of 0.02 to 0.06 mil in thickness.

When a sealing film is applied, it may represent from 20% to 80% of the thickness of the coated polymeric multilayer article, ranging from a lower limit selected from one of 20%, 30%, 40%, or 50% to an upper limit selected from 50%, 60%, 70% or 80%, of the total thickness of the coated polymeric multilayer article, where any lower limit may be paired with any upper limit, when feasible. In such embodiments, the other layers of the film, such as the polyolefin-based layers, adhesion layer, the coating layer and other optional polyolefins or adhesive layers, may sum up to represent from 20% to 80% of the thickness of the coated polymeric multilayer film, ranging from a lower limit selected from one of 20%, 30%, 40%, or 50% to an upper limit selected from 30%, 40%, 50%, 60%, 70% or 80%, where any lower limit may be paired with any upper limit, when feasible.

In one or more embodiments, the coated polymeric multilayer article of the present disclosure has high barrier properties, more preferably ultra-high barrier properties. In this context, “ultra-high barrier properties” means that the coated polymeric multilayer article exhibits low oxygen and water vapor transmission rates, the oxygen transmission rates (“OTR”) being lower than 1.0 cm³/m²/24 h/atm and the water vapor transmission rates (“WVTR”) being lower than 1.0 g/m²/24 h/atm. Both these transmission rates are evaluated at 23° C. and 50% relative humidity.

In one or more embodiments, the coated polymeric multilayer article has an oxygen transmission rate lower than 5.0 cm³/100in₂/24 h/atm, lower than 1.0 cm³/100in₂/24 h/atm, lower than 0.5 cm³/100in₂/24 h/atm at 23° C. and 50% relative humidity, lower than 0.1 cm³/100in₂/24 h/atm, lower than 0.08 cm³/100in₂/24 h/atm, lower than 0.06 cm³/100in₂/24 h/atm or lower than 0.05 cm³/100in₂/24 h/atm according to ASTM F 1927, and ASTM E 104, evaluated at 23° C. and 50% relative humidity.

In one or more embodiments, the coated polymeric multilayer article has a water vapor transmission rate lower than 5.0 g/m²/24 h/atm, lower than 1.0 g/m²/24 h/atm, lower than 0.9 g/m²/24 h/atm, lower than 0.8 g/m²/24 h/atm, lower than 0.7 g/m²/24 h/atm, lower than 0.6 g/m²/24 h/atm or lower than 0.5 g/m²/24 h/atm at 23° C. and 50% relative humidity according to ASTM F 1249, evaluated at 23° C. and 50% relative humidity.

### Method of Producing the Coated Polymeric Multilayer Article

In one aspect, embodiments disclosed herein relate to a method of producing the coated article of any of the present disclosure, the method comprising the steps of:
forming a polymer substrate comprising a first polyolefin-based layer and an adhesion layer on at least one surface of the first polyolefin-based layer; and
applying a coating layer composition on at least one surface of the adhesion layer.

The formation of the polymer substrate according to the present disclosure may use any method known in the art, such as coextrusion and/or lamination of polymers or polyolefins. When lamination processes are used, adhesive layers may be applied between the polyolefin-based, adhesion or coating layers to promote adhesion between them. Polymer substrates such as polymer films may be formed, for example, in a two-step process, where a film is first formed, such as through melt extrusion casting, which is cooled and then reheated to a softened state where it is deformable (below melting temperature) and stretched in one or more directions. In one or more embodiments, the method of producing the polymer substrate comprises coextruding the first polyolefin-based layer and the adhesion layer compositions to produce a casting having adjacent layers, optionally with one or more additional polyolefin- based layers (second, third, fourth, fifth or even additional polyolefin-based layers) to form a casting having the structure: “additional polyolefin-based layer(s)/first polyolefin-based layer/adhesion layer”.

In one or more embodiments, the method of producing the coated polymeric multilayer article further comprises the step of heating while stretching the polymer substrate in both longitudinal and transverse directions to produce an oriented film. In a preferred embodiment, the step of heating while stretching is performed after the formation of the polymer substrate and before the step of applying the coating layer. In a preferred embodiment, the polymer substrate is produced using a tenter frame process.

The manufacture of biaxially oriented films may use a tenter frame process in which, the components of the film are initially mixed and melted within an extruder. The temperature within the extruder may be selected to ensure melting of the components. The extrudate is cast to form a cast film (or flat film) which is then cooled, such as to a temperature less than 70° C. before any reheating process is begun. After cooling, the film is then reheated, and stretching is begun. The temperature during the stretching phase can vary and may decrease as the stretching process continues. Once stretching in the machine direction is complete, the film is annealed. This maintains the machine direction oriented (MDO) film structure for the transversal direction (TD_stretch). Reheating for the second stretching phase is carried out and the temperature can vary during the stretching phase. Finally, the film is allowed to cool.

One or more embodiments for manufacturing films may include the following steps. First, the resin may be melted and homogenized in an extruder, and resulting melt, may be formed into a casting or cast film which is cooled to a temperature less than 70° C. The casting is then heated to temperatures such as between 80 and 110° C. and stretched, such as on a tenter frame, in a machine direction at a ratio between 1:3 to 1:10. It is noted that the indicated temperature may be the temperature at the start of the stretching process and may vary as the stretching process goes on. The MDO-stretched film may then be annealed at temperatures between 50 and 90° C., and then reheated to temperatures between 100 and 150° C. for stretching in transverse direction at a ratio between 1:5 to 1:10. Again, it is noted that the indicated temperature may be the temperature at the start of the stretching process and may vary as the stretching process goes on.

As mentioned above, film production in accordance with the present embodiments can be of any suitable technique including the tenter processing. In tenter frames, the polymer or polymers used to make the film are melted and then passed through an extruder to a slot die mechanism after which it is passed over a first roller, characterized as a chill roller, which tends to solidify the film. The film is then oriented by stressing it in a longitudinal direction, characterized as the machine direction, and in a transverse direction to arrive at a film which can be characterized in terms of orientation ratios, sometimes also referred to as stretch ratios, in both longitudinal and transverse directions.

The machine direction orientation may be accomplished through the use of two sequentially disposed rollers, the second or fast roller operating at a speed in relation to the slower roller corresponding to the desired orientation ratio. This may alternatively be accomplished through a series of rollers with increasing speeds, sometime with additional intermediate rollers for temperature control and other functions. After the film has been stressed in the machine direction, it is again cooled and then pre-heated and passed into a lateral stressing section, for example, a tenter frame mechanism, where it is again stressed, this time in the transverse direction. Orientation in the transverse direction may be followed by an annealing section. Subsequently, the film is then cooled and may be subjected to further treatment, such as a surface treatment (for example corona treatment or flame treatment).

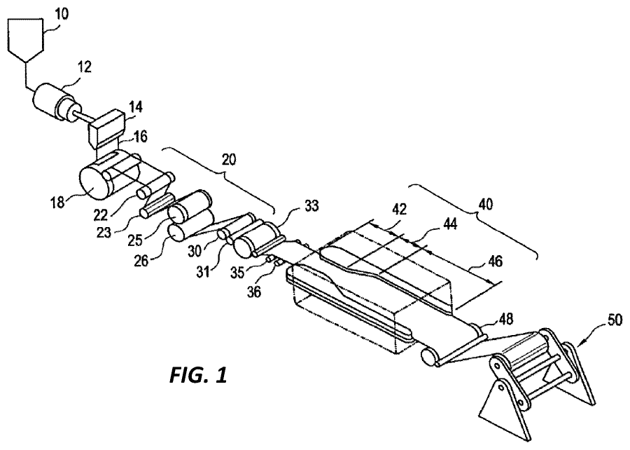

FIG. 1 illustrates a tenter frame that may be employed in producing biaxially oriented polyethylene film in accordance with the present disclosure. In FIG. 1, a source of molten polymer is supplied from a heated hopper 10 to an extruder 12 and from there to a slot die 14 which produces a flat, relatively thick film 16 at its output. Film 16 is applied over a chill roller 18, and it is cooled to a suitable temperature. The film is drawn off the chill roller 18 to a stretching section 20 to which the machine direction orientation occurs by means of idler rollers 22 and 23 that lead to preheat rollers 25 and 26.

As the film is drawn off the chill roller 18 and passed over the idler rollers, it is cooled to a temperature of less than 70° C., such as between 30 and 60° C. In stretching the film in the machine direction, it is heated by preheat rollers 25 and 26 to an incremental temperature increase of about 80-110° C. and is oriented by fast roller 31 operating at a suitable speed greater than that of the preheat rollers in order to orient the film in the machine direction.

As the oriented film is withdrawn from the fast roller 31, it is passed over a roller 33 at room temperature conditions. From here it is passed over rollers to a lateral stretching section 40 where the film is oriented by stretching in the transverse direction. The section 40 includes a preheat section 42 comprising a plurality of tandem heating rollers (not shown) where it is reheated to a temperature within the range of 100-150° C. From the preheat section 42 of the tenter frame, the film is passed to a stretching or draw section 44 where it is progressively stretched by means of tenter clips (not shown) which grasp the opposed sides of the film and progressively stretch it laterally until it reaches its maximum lateral dimension. The concluding portion of the lateral stretching phase includes an annealing section 46, such as an oven housing, where the film is heated at a temperature within the range of 50-90° C. for a suitable period in time. The annealing time helps control certain properties, and increased annealing is often specifically used to reduce shrinkage.

The biaxially oriented film is then withdrawn from the tenter frame and passed over a chill roller 48 where it is reduced to a temperature of less than about 50° C. and then applied to take-up spools on a take up mechanism 50. Typically, the initial orientation in the machine direction is carried out at a somewhat lower temperature than the orientation in the lateral dimension. For example, the film may be stretched in the machine direction at a temperature of about 90° C. and stretched in the lateral dimension at a temperature of 120° C.

During the biaxially stretching, the stretching may have a total stretching ratio in the machine direction ranging from 1:3 to 1:10, and a total stretching ratio in the transverse direction ranging from 1:5 to 1:10. Further, the biaxially stretching may have a machine direction speed ranging from 250 to 750 mm/s.

In one or more embodiments, the stretching ratio in the machine direction may have a lower limit of any of 1:3 or 1:4 to an upper limit of any of 1:7, 1:8, or 1:10, where any lower limit can be used in combination with any upper limit. In one or more embodiments, the stretching ratio in the transverse direction may have a lower limit of any of 1:5 or 1:55 to an upper limit of any of 1:7, 1:9, or 1:10, where any lower limit can be used in combination with any upper limit. Further, in particular embodiments, the MD stretch ratio may be less than the TD stretch ratio.

The step of applying a coating layer composition may use any method known in the art. After the polymer substrate or film is formed, a coating composition is applied on the substrate using known techniques such as rotogravure and flexographic presses. Alternatively, the polymer substrate can be previously treated with a primer layer comprised of water-based cationic copolymers, anionic copolymers, modified polyolefins, preferably, polyolefins comprising polar groups (e.g. polyolefins modified with maleic anhydride), acrylates, among others suitable for polyolefin extrusion coating.

Techniques for applying the coating of the present disclosure are for example described in European Patent 2019852B1, European Patent 2739674B1, European Patent 3129162 and PCT Publication WO 2010/117900, which are incorporated herein by reference.

In one or more embodiments, the coating layer composition is previously produced by mixing the ingredients of the composition.

Additional heating may be applied for the purpose of solvent evaporation of the coating layer to produce a homogeneous layer in the substrate surface, by any known casting technology in the art.

After the coating layer is finished, the method of the present disclosure may also include an additional step of applying a sealing film over the coating layer, using methods known in the art such as lamination, wherein adhesive layers known in the art may be used to adhere the sealing film over the coating layer.

### Packaging

In another aspect, the present disclosure relates to a packaging comprising the coated polymeric multilayer article. The packaging of the present disclosure may be used in any product of interest, not being particularly limited in this regard. In one or more embodiments, the packaging container may be a food package, a homecare product package, a personal care product package, or a package for cosmetic products. In one or more embodiments, the packaging is a pouch, such as a pillow pouch or a stand up pouch.

### Measurement Methods

### MFR

The melt flow rates are measured at 190° C. with a load of 2.16 kg (MFR2) or 6.48 kg (MFR6) according to ASTM D1238.

### Density

The density was measured according to ASTM D792.

### SEx

SEx was measured according to the equations (I) and (II) below:

$$S E x = \frac{log {MFR}_{6} - Log {MFR}_{2}}{Log 6480 - Log 2160} \qquad ( I )$$

$$SEx = \frac{Log R}{0.477} \qquad ( II )$$

where MFR₂ represents a melt flow rate according to ASTM 1238 at 190° C./2.16 kg, MFR₆ represents a melt flow rate according to ASTM 1238 at 190° C./6.48 kg and R is a ratio of MFR₆ and MFR₂.

### Gloss and Haze

Gloss and haze as measured for the optical appearance of the films were determined according to ASTM D2457 (gloss 45°) and ASTM D1003 (haze).

### E-Modulus

E-modulus was measured on the films according to ASTM D882.

Comonomer determination

Comonomer determination was made by NMR spectroscopy. The composition of comonomers (incorporated alpha-olefin) was determined by 13C NMR spectroscopy. Polymers (200 mg) were dissolved in a solvent blend of deuterated tetrachloroethylene and 1,2 dichlorobenzene (25 to 75% v/v) under heating in 10 mm tube. The spectra were recorded with a Bruker AVANCE III HD spectrometer operating at 125 MHz for 13C (1H 500 MHz) at 120° C., using a dul C-H He cooled 10 mm probe. 13C spectra were recorded under the following operating conditions: zgpg30 sequence (with nuclear Overhauser enhancement), acquisition time 2.5 s. relaxation delay 10 s, 1024 scans. Residual carbon Sδ+δ+(δ30.00 ppm) of polyethylene were used as internal reference for 13C NMR spectra, respectively. 13C NMR comonomer content and distributions were determined according by the methodology proposed by J. C. Randall et al. “A Review Of High Resolution Liquid 13Carbon Nuclear Magnetic Resonance Characterizations Of Ethylene-Based Polymers” that provides general methods of polymer analysis by NMR spectroscopy [DOI: 10.1080/07366578908055172] and is incorporated herein in its entirety.

### Molar Mass

Molar Mass (Mw, Mn, Mz, MWD) were measured by GPC 3D. The GPC experiments may be carried out by gel permeation chromatography coupled with triple detection, with an infrared detector IR5 and a four-bridge capillary viscometer (PolymerChar), both provided by Polymer Char, and an eight-angle light scattering detector from Wyatt. A set of 4 mixed bed, 300 mm length and 13 μm particle size columns may be used at a temperature of 140° C. The experiments may use a concentration of 1 mg/mL, a nominal flow rate of 1 mL/min, a dissolution temperature of 160° C. and time ranging from 60 to 120 minutes under shake inside equipment's oven, depending on the sample molecular weight, an injection volume of 200 mL, and a 1,2,4 trichlorobenzene stabilized with 100 ppm of BHT as solvent and mobile phase.

Molecular weight was calculated by means of universal calibration. Intrinsic viscosity was determined from the ratio of specific viscosity (viscometer signal) and concentration (infrared signal) at each slice of chromatogram.

Molecular weight averages and polydispersity were calculated according to Striegel, André Et. al. Modern Size Exclusion Liquid Chromatography: Practice of Gel Permeation and Gel Filtration Chromatograph^{y.} 2nd Edition. New York: John Wiley & Sons, 2009.

### Melt Temperature

Melt temperature was measured by DSC according to ASTM D3418.

### Average Roughness (Ra)

Roughness of the bioriented films is related to surface texture, more specifically, average roughness (Ra) of the bioriented films. The Arithmetic average roughness (Ra) means the absolute values of the profile height deviations from the mean line, recorded within the evaluation length. Ra measurements may be performed using AFM (Nanoscope VIII from Bruker) in tapping mode using a probe of Antimony doped silica (TESP V2 from Bruker) on the bi-oriented films produced according to the present disclosure, where TDX is the “X” axis and MD is the “Y” axis on AFM image. The average roughness (Ra) is evaluated according to ISO 4287:1997 (item 4.2.1). The height image with scan size 40 μm (512 data points per line) were used to perform measures in 5 different lines distributed in the extension of the image. The results reported are the average of these 5 measurements. No plane fit or filter are applied in the image to obtain the measurement.

Rheological parameters

The measurements of the dynamic shear measurements were performed on an DHR3 rotational rheometer, from TA Instruments, equipped with 25 mm parallel plates. Angular frequencies between 0.09 and 500 rad/s were measured at a stress of 200Pa, at 200° C., under a nitrogen atmosphere and setting a gap of 1 mm. Measurements were undertaken on compression molded samples. The sample was placed in a press and heated up to 200° C., for 2 min, under pressure of 30 bar. After the temperature was reached, the sample was pressed at 100 bar for 3 min.

Complex viscosity and loss tangent (tan 8) values at specific angular frequencies (δ) are obtained according to the method above. Elasticity balance (tan 0.09/tan 300) is calculated by the ratio of the loss tangent at 0.09 rad/s to the loss tangent at 300 rad/s.

The determination of the Shear Thinning Index is done as described in equation (III) below.

$${SHI}_{( x / y )} = \frac{{η}^{*} for ( {G}^{*} = x kPa )}{{η}^{*} for ( {G}^{*} = y kPa )} \qquad ( III )$$

For example, the SHI_{(2.7/210)} is defined by the value of the complex viscosity, η*, in Pa·s, determined for a value of complex modulus, G*, equal to 2.7 kPa, divided by the value of the complex viscosity, in Pa·s, determined for a value of G* equal to 210 kPa and the SHI_{(5/210)} is defined by the value of the complex viscosity, η*, in Pa·s, determined for a value of complex modulus, G*, equal to 5 kPa, divided by the value of the complex viscosity, in Pa·s, determined for a value “f#”equal to 200 kPa.

Oxygen Transmission Rate (OTR) and Water Vapor Transmission Rate (WVTR)

OTR was measured according to ASTM F 1927, and ASTM E 104, evaluated at 23° C. and 50% relative humidity.

WVTR was measured according to ASTM F 1249, evaluated at 23° C. and 50% relative humidity.

Tape test

Adhesiveness was measured qualitatively by an internal method, where a commercial tape is placed over the coated substrate and manually peeled. If the coating is not peeled of the substrate, it is considered as a good adhesiveness.

### EXAMPLES

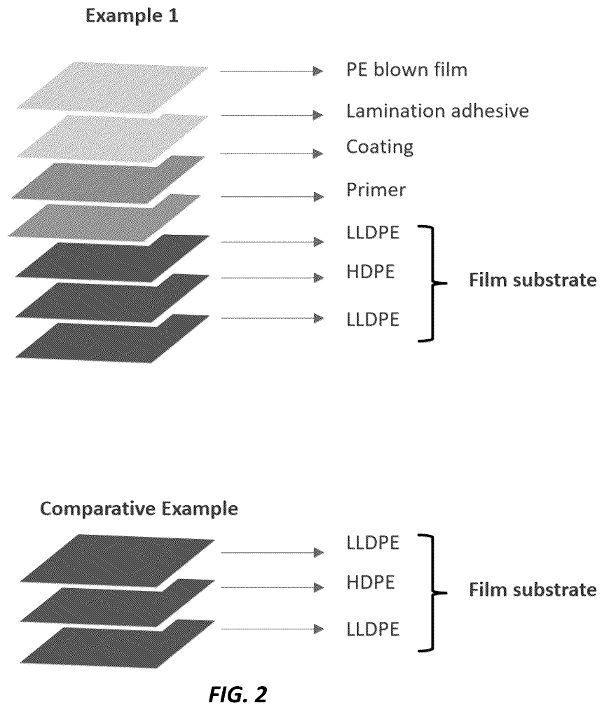

For Comparative Example and Example 1, as shown in FIG. 2, a polymer substrate film comprises a 3-layer film, ABA type, where A is a LLDPE and B is a high density polyethylene. The polymer substrate film was prepared and bioriented in a tenter frame line up to a 25 micron gauge and corona treated up to a surface energy of 38 to 46 dynes, preferentially equal or higher than 42 dynes.

For the Example 1, the polymer substrate film was coated using a OMET 530 Varyflex with 7 station servo press, equipped to print UV, water-based coating, solvent inks with press speed ranges from 32 fpm to 600 fpm, drying capabilities UVH & UVLED (Fj605, 20W/cm2, 395 nm) lamps and hot air tunnel (≤350 oF). In this case, a coating weight of 0.38 gsm was applied, using a speed of 100 fts/min and temperature in the range of 190-200° F.

The coated film from Example 1 was laminated with a blown PE film (sealing layer). For the lamination process was used a temperature of 55° C., a layer of adhesive with a weight of 1.3 gsm, with a surface tension for the coated film of 40 dynes and for the lamination blown PE film of 43 dynes. Adhesive cure time was of 48 hours/ambient temperature with an ambient humidity of 48%. The following are some illustrative results of the barrier properties reach in this invention:

TABLE 1

| | Adhesiveness | | |
|---|---|---|---|
| Example | (tape test) | OTR (cc/m2/day) | WVTR (g/m2/day) |
| CEx1 | Not applicable | >1000 | <10 |
| Ex1 | Good | <1 | <1 |

One can conclude that our solution compared to Comparative Example provides a good adherence of the coating to the film substrate and confers oxygen permeability and water vapor permeability suitable for replacement of barrier polymers as EVOH and polyamide, for a myriad of applications in different segments as food, pet food, beverages, beauty, personal care, home care, but not restricted to these.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed:

1. A coated polymeric multilayer article comprising:
(i) a polymer substrate comprising:
a. a first polyolefin-based layer comprising a primary ethylene-based polymer; and
b. an adhesion layer on at least one surface of the first polyolefin-based layer comprising one or more secondary ethylene-based polymers selected from secondary polyethylene homopolymers, secondary ethylene-based copolymers of ethylene with one or more C3-C10 alpha olefin monomers or ethylene-vinyl acetate (EVA) copolymer; and
(ii) a coating layer on at least one surface of the adhesion layer.

2. The coated article of claim 1, wherein the primary ethylene-based polymers are selected from primary ethylene-based homopolymers and primary ethylene-based copolymers of ethylene with one or more C3-C10 alpha olefin comonomers, preferably the primary ethylene-based polymer of the first polyolefin-based layer is selected from ethylene-based homopolymer, ethylene-based copolymer of ethylene with 1-butene, ethylene-based copolymer of ethylene with 1-hexene, ethylene-based copolymer of ethylene with 1-octene and ethylene-based terpolymer of ethylene with 1-butene and 1-octene.

3. The coated article of claim 1, wherein the primary ethylene-based copolymer of the first polyolefin-based layer has a comonomer content ranging from 0.1 mol % to 10 mol % based on the total number of moles of the primary ethylene-based copolymer, measured by NMR spectroscopy, and an ethylene content ranging from 90 mol % to 99.9 mol %, based on a total number of moles of the ethylene-based copolymer.

4. The coated article of claim 1, wherein the primary ethylene-based polymer of the first polyolefin-based layer is a high density polyethylene (HDPE).

5. The coated article of claim 1, wherein the primary ethylene-based polymer of the first polyolefin-based layer has one or more of the following properties:
a density, according to ASTM D792, ranging from 940 kg/m³ to 961 kg/m³;
a melt flow rate (MFR₂) ranging from 0.5 g/10 min to 3.0 g/10 min according to ASTM D1238 at 190° C./2.16 kg;
a molecular weight distribution (MWD), represented by a ratio of Mw and Mn (Mw/Mn), ranging from 3 to 25; and
a stress exponent (SEx) ranging from 1.0 to 1.8.

6. The coated article of claim 1, wherein the first polyolefin-based layer comprises from 30% to 100% by weight of the primary ethylene-based polymer, based on the total weight of the first polyolefin-based layer.

7. The coated article of claim 1, wherein the first polyolefin-based layer comprises a secondary ethylene-based polymer in a content ranging from 5% to 70% by weight, based on the total weight of the first polyolefin-based layer.

8. The coated article of claim 1, wherein the secondary ethylene-based polymers of the adhesion layer are selected from secondary ethylene-based copolymers of ethylene with 1-butene, secondary ethylene-based copolymers of ethylene with 1-hexene or EVA copolymers, preferably are selected from low linear density polyethylenes (LLDPE) or EVA copolymers.

9. The coated article of claim 1, wherein the adhesion layer comprises from 30% to 100% by weight of one or more secondary ethylene-based polymers, based on the total weight of the adhesion layer.

10. The coated article of claim 1, wherein the adhesion layer comprises a primary ethylene-based polymer in a content ranging from 5% to 70% by weight, based on the total weight of the adhesion layer.

11. The coated article of claim 1, wherein the polymer substrate comprises a second polyolefin-based layer comprising one or more secondary ethylene-based polymers selected from secondary polyethylene homopolymers, secondary ethylene-based copolymers of ethylene with one or more C3-C10 alpha olefin monomers or EVA copolymers.

12. The coated article of claim 1, wherein the coating layer comprises an inorganic material selected from phyllosilicates dispersed and/or exfoliated in a polymer matrix.

13. The coated article of claim 1, wherein the coated article does not contain a primer layer between the adhesion layer of the polymer substrate and the coating layer.

14. The coated article of claim 1, wherein the coated article contains a primer layer between the adhesion layer of the polymer substrate and the coating layer.

15. The coated article of claim 1, further comprising a sealing film applied over the coating layer.

16. The coated article of claim 1, wherein the coated article is a bimaterial article or a monomaterial article.

17. The coated article of claim 1, wherein the article is a coated film selected from the group consisting of a coated blown film, a coated cast film, a coated mono-oriented film or a coated biaxially oriented film.

18. The coated article of claim 17, wherein the coated film has one or more of the following properties:
a haze of 95% or lower, according to ASTM 1003D, when the thickness of the film is 20 μm ;
a gloss at 45° of 5 g.u. or higher, according to ASTM D2457;
an oxygen transmission rate (OTR) lower than 1.0 cm³/m²/day/atm, according to ASTM F 1927 and ASTM E 104, evaluated at 23° C. and 50% relative humidity;
a water vapor transmission rate (WVTR) lower than 1.0 g/m²/day/atm, according to ASTM F 1249, evaluated at 23° C. and 50% relative humidity.

19. A method of producing the coated article of claim 1, the method comprising the steps of:
forming a polymer substrate comprising a first polyolefin-based layer and an adhesion layer on at least one surface of the polyolefin-based layer; and
applying a coating layer composition on at least one surface of the adhesion layer.

20. The method of claim 19, further comprising the step of heating while stretching the polymer substrate in both longitudinal and transverse directions to produce an oriented film, performed after the formation of the polymer substrate and before the step of applying the coating layer.

21. The method of claim 19, wherein the polymer substrate is produced using a tenter frame process.

22. The method of claim 19, wherein the coating layer composition is previously produced by mixing the ingredients of the composition.

23. The method of claim 19, further comprising the step of applying a sealing film over the coating layer.

24. A packaging comprising the polymeric multilayer article of claim 1.

25. The packaging of claim 24, wherein the packaging is a food package, a pet food package, a homecare product package, a personal care product package, or a package for cosmetic products.
